(19) United States
(12) Patent Application Publication
(10) Pub. No.: US 2026/0015457 A1
(43) Pub. Date: Jan. 15, 2026

(54) Liquid Crystalline Polymer Containing Repeating Units Derived from a Furanyl Dicarboxylic Acid

(71) Applicant: Ticona LLC, Florence, KY (US)

(72) Inventors: Xiaowei Zhang, Union, KY (US); Fangfang Tao, Shanghai (CN)

(21) Appl. No.: 19/256,225

(22) Filed: Jul. 1, 2025

Related U.S. Application Data
(60) Provisional application No. 63/669,303, filed on Jul. 10, 2024.

(51) Int. Cl. C08G 63/672

(52) U.S. Cl. CPC C08G 63/672; C08G 2250/00

(57) ABSTRACT

A bio-liquid crystalline polymer is provided. The polymer comprises (i) aromatic dicarboxylic acid repeating units derived from one or more aromatic dicarboxylic acids, wherein the aromatic dicarboxylic acids include one or more furanyl dicarboxylic acids; (ii) aromatic diol repeating units derived from one or more aromatic diols, and (iii) optionally, aromatic hydroxycarboxylic acid repeating units derived from one or more aromatic hydroxycarboxylic acids. The total amount of repeating units derived from naphthenic hydroxycarboxylic and/or dicarboxylic acids is about 10 mol. % or more, and the polymer exhibits a melt viscosity of from about 0.1 to about 150 Pa-s at a shear rate of 1,000 seconds⁻¹.

### RELATED APPLICATION

The present application is based upon and claims priority to U.S. Provisional Patent Application Ser. No. 63/669,303, having a filing date of Jul. 10, 2024, which is incorporated herein by reference.

### BACKGROUND OF THE INVENTION

Liquid crystalline polymers are commonly used in a wide variety of high performance applications, such as in high voltage connectors, medical products, camera modules, and so forth. Such polymers are typically produced by reacting one or more aromatic hydroxycarboxylic acids (e.g., 4-hydroxybenzoic acid (“HBA”) or 2-hydroxy-6-naphthoic acid (“HNA”)) and/or one or dicarboxylic acids (e.g., terephthalic acid (“TA”), isophthalic acid (“IA”), and 2,6-naphthylenedicarboxylic acid (“NDA”) with one or more aromatic diols (e.g., hydroquinone (“HQ”), 4,4′-biphenol (“BP”), etc.) to form ester repeating units. The dicarboxylic acids (TA, IA, and NDA) constitute a significant portion of the aromatic diols employed in most commercial liquid crystalline polymers. Conventionally, TA, IA, and NDA are produced from crude oil through a catalytic cracking process. Recently, however, a need for a more carbon neutral approach has been sought. For example, attempts have been made to use bio-based dicarboxylic acid monomers, such as 2,5-furandicarboxylic acid (“FDCA”), which can be obtained from D-fructose. WO 2013/092667, for instance, describes polymers formed from FDCA, BP, HBA, and vanillic acid. While such polymers do contain some portion of a renewable bio-monomer, the properties are still insufficient to enable their use in most high performance product applications, such as for electronic components used in transmitting and receiving wireless communication signals at high frequencies (e.g., 5G). As such, a need exists for a liquid crystalline polymer that contains renewable bio-monomers and yet still capable of exhibiting properties that enables it use in high performance product applications.

### SUMMARY OF THE INVENTION

In accordance with another embodiment of the present invention, a bio-liquid crystalline polymer is disclosed that comprises (i) aromatic dicarboxylic acid repeating units derived from one or more aromatic dicarboxylic acids, wherein the aromatic dicarboxylic acids include one or more furanyl dicarboxylic acids; (ii) aromatic diol repeating units derived from one or more aromatic diols, and (iii) optionally, aromatic hydroxycarboxylic acid repeating units derived from one or more aromatic hydroxycarboxylic acids. The total amount of repeating units derived from naphthenic hydroxycarboxylic and/or dicarboxylic acids is about 10 mol. % or more, and the polymer exhibits a melt viscosity of from about 0.1 to about 150 Pa-s, as determined at a shear rate of 1,000 seconds⁻¹ and temperature of about 15° C. greater than the melting temperature of the polymer composition in accordance with ISO 11443:2021.

Other features and aspects of the present invention are set forth in greater detail below.

### DETAILED DESCRIPTION

It is to be understood by one of ordinary skill in the art that the present discussion is a description of exemplary embodiments only, and is not intended as limiting the broader aspects of the present invention.

Generally speaking, the present disclosure is directed to a bio-liquid crystalline polymer (“bio-LCP”) that contains aromatic dicarboxylic acid repeating units derived from one or more aromatic dicarboxylic acids; (ii) aromatic diol repeating units derived from one or more aromatic diols, and (iii) optionally, aromatic hydroxycarboxylic acid repeating units derived from one or more aromatic hydroxycarboxylic acids. The aromatic dicarboxylic acid(s) include a furanyl dicarboxylic acid, such as 2,5-furandicarboxylic acid (“FDCA”), 2,2′-bifuran-5,5′-dicarboxylic acid (“BFDCA”), etc., as well as combinations thereof. Typically, the liquid crystalline polymer contains repeating units derived from a furanyl dicarboxylic acid (e.g., FDCA) in an amount of from about 1 mol. % to about 60 mol. %, in some embodiments from about 1 mol. % to about 45 mol. %, in some embodiments from about 1 mol. % to about 30 mol. %, in some embodiments from about 2 mol. % to about 25 mol. %, and in some embodiments, from about 3 mol. % to about 15 mol. % of the polymer.

If desired, the aromatic dicarboxylic acid repeating units may be formed entirely from furanyl dicarboxylic acids. In other embodiments, other aromatic dicarboxylic acids may also be employed in combination with the furanyl dicarboxylic acids, such as 2,6-naphthalenedicarboxylic acid (“NDA”), terephthalic acid (“TA”), isophthalic acid (“IA”), diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. When employed, the additional aromatic dicarboxylic acids may constitute from about 40 mol. % to about 99 mol. %, in some embodiments from about 50 mol. % to about 95 mol. %, and in some embodiments, from about 70 mol. % to about 90 mol. % of the total amount aromatic dicarboxylic acids employed, while the furanyl dicarboxylic acids may likewise constitute from about 1 mol. % to about 60 mol. %, in some embodiments from about 5 mol. % to about 50 mol. %, and in some embodiments, from about 10 mol. % to about 30 mol. % of the total amount aromatic dicarboxylic acids employed. For example, the liquid crystalline polymer may contain repeating units derived from additional dicarboxylic acids (e.g., NDA, TA, and/or IA) in an amount of from about 10 mol. % to about 40 mol. %, in some embodiments from about 12 mol. % to about 35 mol. %, and in some embodiments, from about 15 mol. % to about 30 mol. %, and repeating units derived from furanyl dicarboxylic acids (e.g., FDCA) in an amount of from about 1 mol. % to about 30 mol. %, in some embodiments from about 2 mol. % to about 25 mol. %, and in some embodiments, from about 3 mol. % to about 15 mol. % of the polymer.

In certain embodiments, the aromatic hydroxycarboxylic acid(s) may include 4-hydroxybenzoic acid (“HBA”), 6-hydroxy-2-naphthoic acid (“HNA”), 4-hydroxy-4′-biphenylcarboxylic acid, 2-hydroxy-6-naphthoic acid, 2-hydroxy-5-naphthoic acid, 3-hydroxy-2-naphthoic acid, 2-hydroxy-3-naphthoic acid, 4′-hydroxyphenyl-4-benzoic acid, 3′-hydroxyphenyl-4-benzoic acid, 4′-hydroxyphenyl-3-benzoic acid, etc., as well as alkyl, alkoxy, aryl and halogen substituents thereof, and combination thereof. The aromatic diols may include hydroquinone (“HQ”), 4,4′-biphenol (“BP”), resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof.

The relative amounts of the monomeric constituents of the liquid crystalline polymer can be selectively controlled to help achieve the desired properties. For example, the monomeric constituents may be selectively controlled so that the polymer is considered a “high naphthenic” polymer the extent that it contains a relatively high content of repeating units derived from naphthenic hydroxycarboxylic acids and naphthenic dicarboxylic acids, such as NDA, HNA, or combinations thereof. That is, the total amount of repeating units derived from naphthenic hydroxycarboxylic and/or dicarboxylic acids (e.g., NDA, HNA, or a combination of HNA and NDA) is typically about 10 mol. % or more, in some embodiments about 12 mol. % or more, in some embodiments about 15 mol. % or more, in some embodiments about 18 mol. % or more, and in some embodiments, from about 20 mol. % to about 80 mol. % of the polymer. Without intending to be limited by theory, it is believed that such “high naphthenic” polymers are capable of reducing the tendency of the polymer composition to absorb water, which can help improve the electrical properties of the polymer at high frequency ranges. Namely, such high naphthenic polymers typically have a water adsorption of about 0.015% or less, in some embodiments about 0.01% or less, and in some embodiments, from about 0.0001% to about 0.008% after being immersed in water for 24 hours in accordance with ISO 62-1:2008. The high naphthenic polymers may also have a moisture adsorption of about 0.01% or less, in some embodiments about 0.008% or less, and in some embodiments, from about 0.0001% to about 0.006% after being exposed to a humid atmosphere (50% relative humidity) at a temperature of 23° C. in accordance with ISO 62-4:2008.

In one embodiment, for instance, the liquid crystalline polymer may contain repeating units derived from NDA in an amount of from about 10 mol. % to about 40 mol. %, in some embodiments from about 12 mol. % to about 35 mol. %, and in some embodiments, from about 15 mol. % to about 30 mol. %. In such embodiments, the liquid crystalline polymer may likewise contain repeating units derived from a furanyl dicarboxylic acid (e.g., FDCA) in an amount of from about 1 mol. % to about 30 mol. %, in some embodiments from about 2 mol. % to about 25 mol. %, and in some embodiments, from about 3 mol. % to about 15 mol. % of the polymer. Of course, in addition to NDA and furanyl dicarboxylic acids, the liquid crystalline polymer may also contain other repeating units derived from aromatic dicarboxylic acids as noted above. For example, in certain embodiments, the liquid crystalline polymer(s) may contain repeating units derived from TA and/or IA. Desirably, however, the content of such acids may be minimized to optimize the bio-content of the polymer. That is, the total amount of TA and/or IA may be about 20 mol. % or less, in some embodiments about 18 mol. % or less, and in some embodiments, about 15 mol. % or less (e.g., 0 mol. %) of the polymer.

The liquid crystalline polymer may also contain repeating units derived aromatic diols (e.g., HQ and/or BP), which in total, may constitute from about 5 mol. % to about 40 mol. %., in some embodiments from about 10 mol. % to about 35 mol. %, and in some embodiments, from about 15 mol. % to about 30 mol. % of the polymer. The total amount of aromatic dicarboxylic acids (e.g., NDA, FDCA, IA, and/or TA) may be equimolar or in molar excess relative to the total amount of aromatic diols (e.g., HQ and/or BP) to help achieve the desired properties. For example, the ratio of the moles of repeating units derived from aromatic dicarboxylic acids to the moles of repeating units derived from aromatic diols may be about 1 or more, in some embodiments from about 1 to about 1.5, and in some embodiments, from about 1.001 to about 1.3. In addition to the components noted above, the liquid crystalline polymer(s) may contain repeating units derived from HBA, which may constitute from about 10 mol. % to about 70 mol. %, and in some embodiments from about 20 mol. % to about 65 mol. %, and in some embodiments, from about 30 mol. % to about 60 mol. %. When employed, the molar ratio of HBA to furanyl dicarboxylic acids (e.g., FDCA) may be selectively controlled within a specific range to help achieve the desired properties, such as from about 1 to about 20, in some embodiments from about 2 to about 18, and in some embodiments, from about 3 to about 10. The molar ratio of HBA to NDA, when employed, may likewise be from about 0.1 to about 20, in some embodiments from about 0.5 to about 15, and in some embodiments, from about 1 to about 10.

Of course, other monomer components may also be employed in the liquid crystalline polymer, such as those derived from one or more aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10 mol. % of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Of course, in other embodiments, the polymer may be “wholly aromatic” in that it lacks repeating units derived from non-aromatic (e.g., aliphatic or cycloaliphatic) monomers.

Regardless of the particular constituents and nature of the polymer, the bio-LCP may be prepared by initially introducing the aromatic monomer(s) used to form the repeating units (e.g., aromatic hydroxycarboxylic acid(s), aromatic dicarboxylic acid(s), aromatic diol(s), etc.) into a reactor vessel to initiate a polycondensation reaction. The particular conditions and steps employed in such reactions are well known, and may be described in more detail in U.S. Pat. No. 4,161,470 to Calundann; U.S. Pat. No. 5,616,680 to Linstid, III, et al.; U.S. Pat. No. 6,114,492 to Linstid, III, et al.; U.S. Pat. No. 6,514,611 to Shepherd, et al.; and WO 2004/058851 to Waggoner. The vessel employed for the reaction is not especially limited, although it is typically desired to employ one that is commonly used in reactions of high viscosity fluids. Examples of such a reaction vessel may include a stirring tank-type apparatus that has an agitator with a variably-shaped stirring blade, such as an anchor type, multistage type, spiral-ribbon type, screw shaft type, etc., or a modified shape thereof. Further examples of such a reaction vessel may include a mixing apparatus commonly used in resin kneading, such as a kneader, a roll mill, a Banbury mixer, etc.

If desired, the reaction may proceed through the acetylation of the monomers as known the art. This may be accomplished by adding an acetylating agent (e.g., acetic anhydride) to the monomers. Acetylation is generally initiated at temperatures of about 90° C. During the initial stage of the acetylation, reflux may be employed to maintain vapor phase temperature below the point at which acetic acid byproduct and anhydride begin to distill. Temperatures during acetylation typically range from between 90° C. to 150° C., and in some embodiments, from about 110° C. to about 150° C. If reflux is used, the vapor phase temperature typically exceeds the boiling point of acetic acid, but remains low enough to retain residual acetic anhydride. For example, acetic anhydride vaporizes at temperatures of about 140° C. Thus, providing the reactor with a vapor phase reflux at a temperature of from about 110° C. to about 130° C. is particularly desirable. To ensure substantially complete reaction, an excess amount of acetic anhydride may be employed. The amount of excess anhydride will vary depending upon the particular acetylation conditions employed, including the presence or absence of reflux. The use of an excess of from about 1 to about 10 mole percent of acetic anhydride, based on the total moles of reactant hydroxyl groups present is not uncommon.

Acetylation may occur in in a separate reactor vessel, or it may occur in situ within the polymerization reactor vessel. When separate reactor vessels are employed, one or more of the monomers may be introduced to the acetylation reactor and subsequently transferred to the polymerization reactor. Likewise, one or more of the monomers may also be directly introduced to the reactor vessel without undergoing pre-acetylation.

In addition to the monomers and optional acetylating agents, other components may also be included within the reaction mixture to help facilitate polymerization. For instance, a catalyst may be optionally employed, such as metal salt catalysts (e.g., magnesium acetate, tin(I) acetate, tetrabutyl titanate, lead acetate, sodium acetate, potassium acetate, etc.) and organic compound catalysts (e.g., N-methylimidazole). Such catalysts are typically used in amounts of from about 50 to about 500 parts per million based on the total weight of the recurring unit precursors. When separate reactors are employed, it is typically desired to apply the catalyst to the acetylation reactor rather than the polymerization reactor, although this is by no means a requirement.

The reaction mixture is generally heated to an elevated temperature within the polymerization reactor vessel to initiate melt polycondensation of the reactants. Polycondensation may occur, for instance, within a temperature range of from about 200° C. to about 400° C. For instance, one suitable technique for forming the polymer may include charging precursor monomers and acetic anhydride into the reactor, heating the mixture to a temperature of from about 90° C. to about 150° C. to acetylize a hydroxyl group of the monomers (e.g., forming acetoxy), and then increasing the temperature to from about 200°° C. to about 400° C. to carry out melt polycondensation. As the final polymerization temperatures are approached, volatile byproducts of the reaction (e.g., acetic acid) may also be removed so that the desired molecular weight may be readily achieved. The reaction mixture is generally subjected to agitation during polymerization to ensure good heat and mass transfer, and in turn, good material homogeneity. The rotational velocity of the agitator may vary during the course of the reaction, but typically ranges from about 10 to about 100 revolutions per minute (“rpm”), and in some embodiments, from about 20 to about 80 rpm. To build molecular weight in the melt, the polymerization reaction may also be conducted under vacuum, the application of which facilitates the removal of volatiles formed during the final stages of polycondensation. The vacuum may be created by the application of a suctional pressure, such as within the range of from about 5 to about 30 pounds per square inch (“psi”), and in some embodiments, from about 10 to about 20 psi.

Following melt polymerization, the molten polymer may be discharged from the reactor, typically through an extrusion orifice fitted with a die of desired configuration, cooled, and collected. Commonly, the melt is discharged through a perforated die to form strands that are taken up in a water bath, pelletized and dried. In some embodiments, the melt polymerized polymer may also be subjected to a subsequent solid-state polymerization method to further increase its molecular weight. Solid-state polymerization may be conducted in the presence of a gas (e.g., air, inert gas, etc.). Suitable inert gases may include, for instance, nitrogen, helium, argon, neon, krypton, xenon, etc., as well as combinations thereof. The solid-state polymerization reactor vessel can be of virtually any design that will allow the polymer to be maintained at the desired solid-state polymerization temperature for the desired residence time. Examples of such vessels can be those that have a fixed bed, static bed, moving bed, fluidized bed, etc. The temperature at which solid-state polymerization is performed may vary, but is typically within a range of from about 200° C. to about 400° C. The polymerization time will of course vary based on the temperature and target molecular weight. In most cases, however, the solid-state polymerization time will be from about 2 to about 12 hours, and in some embodiments, from about 4 to about 10 hours.

Once formed, the resulting bio-LCP may have a “bio-content” of about 1 mol. % to 100 mol. %, in some embodiments about 2 mol. % to about mol. %, in some embodiments from about 3 mol. % to about 70 mol. %, and in some embodiments, from about 5 mol. % to about 60 mol. % based on the total molar concentration of monomers (repeating units) employed in the polymer. As used herein, the term “bio-content” generally refers to the molar percentage of monomers (repeating units) that are derived from a renewable feedstock, such as those in which the carbon stem from non-fossil biological sources, such as microalgae, carbohydrates (e.g., starch, sugars, etc.), bacteria, natural oils, etc. Glucose and other hexoses (e.g., fructose) may be converted into as 5-hydroxymethyl-2-furaldehyde, also known as 5-hydroxymethylfurfural or simply hydroxymethylfurfural (“HMF”). As is well known in art and described, for instance, in U.S. Pat. No. 10,538,499 to Howard, et al., FDCA can be formed through the oxidation of HMF and thus serve as a renewable feedstock. It should thus should be understood that this molar percentage may include the furanyl dicarboxylic acids described herein (e.g., FDCA), as well as other monomer components that may also be derived from a renewable feedstock, such as bio-4-hydroxybenzoic acid (“bio-HBA”), bio-terephthalic acid (“bio-TA”), bio-isophthalic acid (“bio-IA”), bio-4,4′-biophenol (“bio-BP”), bio-hydroquinone (“bio-HQ”), bio-2-hydroxy-6-naphthoic acid (“bio-HNA”), bio-2,6-naphthalenedicarboxylic acid (“bio-NDA”), bio-4-aminophenol (“bio-AP”), bio-acetaminophen (“bio-APAP”), etc.

Despite containing such a high bio-content, the resulting bio-LCP is still capable of exhibiting similar properties to liquid crystalline polymers formed from traditional fossil fuel sources. Namely, the bio-LCP is still considered “thermotropic” to the extent that it can possess a rod-like structure and exhibit a crystalline behavior in its molten state (e.g., thermotropic nematic state). The bio-LCP also typically has a high melting temperature such as from about 280° C. to about 400° C., in some embodiments from about 290° C. to about 380° C., and in some embodiments, from about 300° C. to about 350° C., such as determined using differential scanning calorimetry (“DSC”), such as determined by ISO 11357-3:2018. Even at such melting temperatures, the ratio of the deflection temperature under load (“DTUL”), a measure of short term heat resistance, to the melting temperature may still remain relatively high. For example, the ratio may range from about 0.5 to about 1.00, in some embodiments from about 0.6 to about 0.95, and in some embodiments, from about 0.65 to about 0.85. The specific DTUL values may, for instance, be about 200° C. or more, in some embodiments about 220° C. or more, in some embodiments from about 230° C. to about 300° C., and in some embodiments, from about 210° C. to about 280° C. Such high DTUL values can, among other things, allow the use of high speed and reliable surface mounting processes for mating the structure with other components of the electrical component.

Through selective control of the particular monomeric constituents and their relative concentrations, as noted above, the resulting polymer has also been found to exhibit a variety of other good properties, which may can enable its use in various high performance product applications. For example, the polymer may exhibit excellent melt processability and a high degree of flowability. For example, the polymer may have an ultralow melt viscosity, such as from about 0.1 to about 150 Pa-s, in some embodiments from about 0.2 to about 100 Pa-s, in some embodiments from about 0.5 to about 80 Pa-s, and in some embodiments, from about 1 to about 60 Pa-s, determined at a shear rate of 1,000 seconds⁻¹ and temperature of about 15° C. greater than the melting temperature of the polymer composition in accordance with ISO 11443:2021.

The polymer may also exhibit a low dielectric constant and dissipation factor over a wide range of frequencies, making it particularly suitable for use in high frequency product applications. For example, the polymer may exhibit a low dielectric constant of about 5 or less, in some embodiments about 4.5 or less, in some embodiments from about 0.1 to about 4.4 and in some embodiments, from about 1 to about 4.2, in some embodiments, from about 1.5 to about 4, in some embodiments from about 2 to about 3.9, and in some embodiments, from about 2.5 to about 3.5 over typical 5G frequencies (e.g., 2 or 10 GHz). The dissipation factor of the polymer, which is a measure of the loss rate of energy, may likewise be about 0.05 or less, in some embodiments about 0.01 or less, in some embodiments from about 0.0001 to about 0.008, and in some embodiments from about 0.0002 to about 0.006 over typical 5G frequencies (e.g., 2 or 10 GHZ). In fact, in some cases, the dissipation factor may be very low, such as about 0.003 or less, in some embodiments about 0.002 or less, in some embodiments about 0.001 or less, in some embodiments, about 0.0009 or less, in some embodiments about 0.0008 or less, and in some embodiments, from about 0.0001 to about 0.0007 over typical 5G frequencies (e.g., 2 or 10 GHz).

The polymer may also possess excellent mechanical properties. For example, the polymer may exhibit a tensile strength of about 10 MPa or more, in some embodiments about 50 MPa or more, in some embodiments from about 70 MPa to about 300 MPa, and in some embodiments from about 80 MPa to about 200 MPa. The polymer may exhibit a tensile elongation of about 0.3% or more, in some embodiments about 0.4% or more, in some embodiments from about 0.5% to about 4%, and in some embodiments from about 0.5% to about 2%. The polymer may exhibit a tensile modulus of about 5,000 MPa or more, in some embodiments about 6,000 MPa or more, in some embodiments about 7,000 MPa to about 25,000 MPa, and in some embodiments from about 10,000 MPa to about 20,000 MPa. The tensile properties may be determined at a temperature of 23° C. in accordance with ISO Test No. 527:2012. Also, the polymer may exhibit a flexural strength of about 20 MPa or more, in some embodiments about 30 MPa or more, in some embodiments about 50 MPa or more, in some embodiments from about 70 MPa to about 300 MPa, and in some embodiments from about 80 MPa to about 200 MPa. The polymer may exhibit a flexural elongation of about 0.4% or more, in some embodiments from about 0.5% to about 4%, and in some embodiments from about 0.5% to about 2%. The polymer may exhibit a flexural modulus of about 5,000 MPa or more, in some embodiments about 6,000 MPa or more, in some embodiments about 7,000 MPa to about 25,000 MPa, and in some embodiments from about 10,000 MPa to about 20,000 MPa. The flexural properties may be determined at a temperature of 23° C. in accordance with 178:2010. Furthermore, the polymer may also possess a high impact strength, which may be useful when forming thin substrates. The polymer may, for instance, possess a Charpy notched impact strength of about 3 kJ/m² or more, in some embodiments about 5 kJ/m² or more, in some embodiments about 7 kJ/m² or more, in some embodiments from about 8 kJ/m² to about 40 kJ/m², and in some embodiments from about 10 kJ/m² to about 25 kJ/m². The impact strength may be determined at a temperature of 23° C. in accordance with ISO Test No. ISO 179-1:2010.

The bio-LCP may be used in neat form (i.e., composition containing 100 wt. % of bio-LCP(s)) or blended with other components to form a polymer composition. In such embodiments, bio-LCP(s) typically constitute from about 10 wt. % to about 90 wt. %, in some embodiments from about 20 wt. % to about 80 wt. %, in some embodiments from about 25 wt. % to about 70 wt. %, and in some embodiments, from about 30 wt. % to about 60 wt. % of the polymer composition. In such embodiments, other additives likewise constitute from about 10 wt. % to about 90 wt. %, in some embodiments from about 20 wt. % to about 80 wt. %, in some embodiments from about 30 wt. % to about 75 wt. %, and in some embodiments, from about 40 wt. % to about 70 wt. % of the polymer composition. If desired, the other additives may also be derived from a sustainable source, such as recycled materials, renewable materials, bio-based materials, etc. For example, the total “sustainable content” of the polymer composition is typically from about 5 wt. % to 100 wt. %, in some embodiments from about 10 wt. % to about 90 wt. %, and in some embodiments, from about 20 wt. % to about 80 wt. % based on the total weight of the composition. The term “sustainable content” generally refers to the weight percentage of components that are derived from a sustainable source. For a composition containing only bio-LCP, for example, the “sustainable content” is the same as the “bio-content” (weight percentage of monomers derived from bio-naphtha). For compositions containing bio-LCP, other sustainable materials (e.g., recycled materials), non-sustainable materials (e.g., fossil fuel-based materials, virgin materials, etc.), the “sustainable content” can be determined as follows:
(Weight of Bio-LCP)*(“Bio-Content”)+(Weight of Other Sustainable Materials)/Weight of Polymer Composition

Various examples of other additives that can be used in the polymer composition are set forth below.

The polymer composition may, for example, contain one or more mineral fillers. When employed, such mineral filler(s) typically constitute from about 1 wt. % to about 50 wt. %, in some embodiments from about 2 wt. % to about 45 wt. %, and in some embodiments, from about 5 wt. % to about 40 wt. % of the polymer composition. The nature of the mineral filler(s) employed in the polymer composition may vary, such as mineral particles, mineral fibers (or “whiskers”), etc., as well as blends thereof. Typically, the mineral filler(s) employed in the polymer composition have a certain hardness value to help improve the mechanical strength, adhesive strength, and surface properties of the composition. For instance, the hardness values may be about 2.0 or more, in some embodiments about 2.5 or more, in some embodiments about 3.0 or more, in some embodiments from about 3.0 to about 11.0, in some embodiments from about 3.5 to about 11.0, and in some embodiments, from about 4.5 to about 6.5 based on the Mohs hardness scale.

Any of a variety of different types of mineral particles may generally be employed in the polymer composition, such as those formed from a natural and/or synthetic silicate mineral, such as talc, mica, silica (e.g., amorphous silica), alumina, halloysite, kaolinite, illite, montmorillonite, vermiculite, palygorskite, pyrophyllite, calcium silicate, aluminum silicate, wollastonite, etc.; sulfates; carbonates; phosphates; fluorides, borates; and so forth. Particularly suitable are particles include talc, calcium carbonate (CaCO₃), copper carbonate hydroxide (Cu₂CO3(OH)₂); calcium fluoride (CaFl₂); calcium pyrophosphate ((Ca₂P₂O₇), anhydrous dicalcium phosphate (CaHPO₄), hydrated aluminum phosphate (AlPO₄·2H₂O); silica (SiO₂), potassium aluminum silicate (KAlSi₃O₈), copper silicate (CuSiO₃·H₂O); calcium borosilicate hydroxide (Ca₂B₅SiO₉(OH)₅); alumina (AlO₂); calcium sulfate (CaSO₄), barium sulfate (BaSO₄), talc, mica, and so forth, as well as combinations thereof. Talc, mica, calcium carbonate, and barium sulfate are particularly suitable. Any form of mica may generally be employed, including, for instance, muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), glauconite (K,Na)(Al,Mg,Fe)₂(Si,Al)₄O₁₀(OH)₂), etc.

In certain embodiments, the mineral particles, such as barium sulfate and/or calcium sulfate particles, may have a shape that is generally granular or nodular in nature. In such embodiments, the particles may have a median size (e.g., diameter) of from about 0.5 to about 20 micrometers, in some embodiments from about 1 to about 15 micrometers, in some embodiments from about 1.5 to about 10 micrometers, and in some embodiments, from about 2 to about 8 micrometers, such as determined using laser diffraction techniques in accordance with ISO 13320:2009 (e.g., with a Horiba LA-960 particle size distribution analyzer). In other embodiments, it may also be desirable to employ flake-shaped mineral particles, such as mica particles, that have a relatively high aspect ratio (e.g., average diameter divided by average thickness), such as about 4 or more, in some embodiments about 8 or more, and in some embodiments, from about 10 to about 500. In such embodiments, the average diameter of the particles may, for example, range from about 5 micrometers to about 200 micrometers, in some embodiments from about 8 micrometers to about 150 micrometers, and in some embodiments, from about 10 micrometers to about 100 micrometers. The average thickness may likewise be about 2 micrometers or less, in some embodiments from about 5 nanometers to about 1 micrometer, and in some embodiments, from about 20 nanometers to about 500 nanometers such as determined using laser diffraction techniques in accordance with ISO 13320:2009 (e.g., with a Horiba LA-960 particle size distribution analyzer). The mineral particles may also have a narrow size distribution. That is, at least about 70% by volume of the particles, in some embodiments at least about 80% by volume of the particles, and in some embodiments, at least about 90% by volume of the particles may have a size within the ranges noted above.

Suitable mineral fibers may likewise include those that are derived from silicates, such as neosilicates, sorosilicates, inosilicates (e.g., calcium inosilicates, such as wollastonite; calcium magnesium inosilicates, such as tremolite; calcium magnesium iron inosilicates, such as actinolite; magnesium iron inosilicates, such as anthophyllite; etc.), phyllosilicates (e.g., aluminum phyllosilicates, such as palygorskite), tectosilicates, etc.; sulfates, such as calcium sulfates (e.g., dehydrated or anhydrous gypsum); mineral wools (e.g., rock or slag wool); and so forth. Particularly suitable are fibers having the desired hardness value, including fibers derived from inosilicates, such as wollastonite (Mohs hardness of 4.5 to 5.0), which are commercially available from Nyco Minerals under the trade designation Nyglos® (e.g., Nyglos® 4W or Nyglos® 8). The mineral fibers may have a median width (e.g., diameter) of from about 1 to about 35 micrometers, in some embodiments from about 2 to about 20 micrometers, in some embodiments from about 3 to about 15 micrometers, and in some embodiments, from about 7 to about 12 micrometers. The mineral fibers may also have a narrow size distribution. That is, at least about 60% by volume of the fibers, in some embodiments at least about 70% by volume of the fibers, and in some embodiments, at least about 80% by volume of the fibers may have a size within the ranges noted above. In addition to possessing the size characteristics noted above, the mineral fibers may also have a relatively high aspect ratio (average length divided by median width) to help further improve the mechanical properties and surface quality of the resulting polymer composition. For example, the mineral fibers may have an aspect ratio of from about 2 to about 100, in some embodiments from about 2 to about 50, in some embodiments from about 3 to about 20, and in some embodiments, from about 4 to about 15. The volume average length of such mineral fibers may, for example, range from about 1 to about 200 micrometers, in some embodiments from about 2 to about 150 micrometers, in some embodiments from about 5 to about 100 micrometers, and in some embodiments, from about 10 to about 50 micrometers.

A fibrous filler may also be employed in the polymer composition. The fibrous filler typically includes fibers having a high degree of tensile strength relative to their mass. For example, the ultimate tensile strength of the fibers (determined in accordance with ASTM D2101) is typically from about 1,000 to about 15,000 Megapascals (“MPa”), in some embodiments from about 2,000 MPa to about 10,000 MPa, and in some embodiments, from about 3,000 MPa to about 6,000 MPa. To help maintain the desired properties, such high strength fibers may be formed from materials that are generally insulative in nature, such as glass, ceramics (e.g., alumina or silica), aramids (e.g., Kevlar® marketed by E. I. du Pont de Nemours, Wilmington, Del.), polyolefins, polyesters, etc. Glass fibers are particularly suitable, such as E-glass, A-glass, C-glass, D-glass, AR-glass, R-glass, S1-glass, S2-glass, etc. If desired, all or a portion of such fibers may be recycled.

Although the fibers employed in the fibrous filler may have a variety of different sizes, fibers having a certain aspect ratio can help improve the mechanical properties of the resulting polymer composition. That is, fibers having an aspect ratio (average length divided by nominal diameter) of from about 5 to about 50, in some embodiments from about 6 to about 40, and in some embodiments, from about 8 to about 25 are particularly beneficial. Such fibers may, for instance, have a weight average length of from about 100 to about 800 micrometers, in some embodiments from about 120 to about 500 micrometers, in some embodiments, from about 150 to about 350 micrometers, and in some embodiments, from about 200 to about 300 micrometers. The fibers may likewise have a nominal diameter of about 6 to about 35 micrometers, and in some embodiments, from about 9 to about 18 micrometers. The relative amount of the fibrous filler may also be selectively controlled to help achieve the desired mechanical and thermal properties. For example, the fibrous filler may constitute from about 1 wt. % to about 40 wt. %, in some embodiments from about 3 wt. % to about 30 wt. %, and in some embodiments, from about 5 wt. % to about 20 wt. % of the polymer composition.

An impact modifier may also be employed in the polymer composition. For example, the impact modifier may be a polymer that contains an olefinic monomeric unit that derived from one or more a-olefins. Examples of such monomers include, for instance, linear and/or branched a-olefins having from 2 to 20 carbon atoms and typically from 2 to 8 carbon atoms. Specific examples include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin monomers are ethylene and propylene. The olefin polymer may be in the form of a copolymer that contains other monomeric units as known in the art. For example, another suitable monomer may include a “(meth)acrylic” monomer, which includes acrylic and methacrylic monomers, as well as salts or esters thereof, such as acrylate and methacrylate monomers. Examples of such (meth)acrylic monomers may include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. In one embodiment, for instance, the impact modifier may be an ethylene methacrylic acid copolymer (“EMAC”). When employed, the relative portion of the monomeric component(s) may be selectively controlled. The α-olefin monomer(s) may, for instance, constitute from about 55 wt. % to about 95 wt. %, in some embodiments from about 60 wt. % to about 90 wt. %, and in some embodiments, from about 65 wt. % to about 85 wt. % of the copolymer. Other monomeric components (e.g., (meth)acrylic monomers) may constitute from about 5 wt. % to about 35 wt. %, in some embodiments from about 10 wt. % to about 32 wt. %, and in some embodiments, from about 15 wt. % to about 30 wt. % of the copolymer.

Other suitable olefin copolymers may be those that are “epoxy-functionalized” in that they contain, on average, two or more epoxy functional groups per molecule. The copolymer may also contain an epoxy-functional monomeric unit. One example of such a unit is an epoxy-functional (meth)acrylic monomeric component. For example, suitable epoxy-functional (meth)acrylic monomers may include, but are not limited to, those containing 1,2-epoxy groups, such as glycidyl acrylate and glycidyl methacrylate. Other suitable epoxy-functional monomers include allyl glycidyl ether, glycidyl ethylacrylate, and glycidyl itoconate. Other suitable monomers may also be employed to help achieve the desired molecular weight. In one particular embodiment, for example, the copolymer may be a terpolymer formed from an epoxy-functional (meth)acrylic monomeric component, a-olefin monomeric component, and non-epoxy functional (meth)acrylic monomeric component. The copolymer may, for instance, be poly (ethylene-co-butylacrylate-co-glycidyl methacrylate). When employed, the epoxy-functional (meth)acrylic monomer(s) typically constitutes from about 1 wt. % to about 20 wt. %, in some embodiments from about 2 wt. % to about 15 wt. %, and in some embodiments, from about 3 wt. % to about 10 wt. % of the copolymer.

When employed, impact modifiers typically constitute from about 0.5 to about 60 parts, in some embodiments from about 1 to about 50 parts, and in some embodiments, from about 2 to about 30 parts by weight per 100 parts by weight of the liquid crystalline polymers employed in the composition. For example, impact modifiers may constitute from about 0.1 wt. % to about 30 wt. %, in some embodiments from about 0.5 wt. % to about 25 wt. %, and in some embodiments, from about 1 wt. % to about 20 wt. % of the polymer composition.

Although by no means required, the polymer composition may be “laser activatable” in the sense that it contains an additive that can be activated by a laser direct structuring (“LDS”) process. In such a process, the additive is exposed to a laser that causes the release of metals. The laser thus draws the pattern of conductive elements onto the part and leaves behind a roughened surface containing embedded metal particles. These particles act as nuclei for the crystal growth during a subsequent plating process (e.g., copper plating, gold plating, nickel plating, silver plating, zinc plating, tin plating, etc.). The laser activatable additive generally includes oxide crystals, which may include two or more metal oxide cluster configurations within a definable crystal formation. For example, the overall crystal formation may have the following general formula:
AB₂O₄ or ABO₂
   wherein,
A is a metal cation having a valance of 2 or more, such as cadmium, chromium, manganese, nickel, zinc, copper, cobalt, iron, magnesium, tin, titanium, etc., as well as combinations thereof; and
B is a metal cation having a valance of 3 or more, such as antimony, chromium, iron, aluminum, nickel, manganese, tin, etc., as well as combinations thereof.

Typically, A in the formula above provides the primary cation component of a first metal oxide cluster and B provides the primary cation component of a second metal oxide cluster. These oxide clusters may have the same or different structures. In one embodiment, for example, the first metal oxide cluster has a tetrahedral structure and the second metal oxide cluster has an octahedral cluster. Regardless, the clusters may together provide a singular identifiable crystal type structure having heightened susceptibility to electromagnetic radiation. Examples of suitable oxide crystals include, for instance, MgAl₂O₄, ZnAl₂O₄, FeAl₂O₄, CuFe₂O₄, CuCr₂O₄, MnFe₂O₄, NiFe₂O₄, TiFe₂O₄, FeCr₂O₄, MgCr₂O₄, tin/antimony oxides (e.g., (Sb/Sn)O₂), and combinations thereof. Copper chromium oxide (CuCr₂O₄) is particularly suitable for use in the present invention and is available from Shepherd Color Co. under the designation “Shepherd Black 1GM.” In some cases, the laser activatable additive may also have a core-shell configuration, such as described in WO 2018/130972. In such additives, the shell component of the additive is typically laser activatable, while the core may be any general compound, such as an inorganic compound (e.g., titanium dioxide, mica, talc, etc.).

When employed, laser activatable additives typically constitute from about 0.1 wt. % to about 30 wt. %, in some embodiments from about 0.5 wt. % to about 20 wt. %, and in some embodiments, from about 1 wt. % to about 10 wt. % of the polymer composition. Of course, the polymer composition may also be free (i.e., 0 wt. %) of such laser activatable additives, such as spinel crystals, or such additives may be present in only a small concentration, such as in an amount of about 1 wt. % or less, in some embodiments about 0.5 wt. % or less, and in some embodiments, from about 0.001 wt. % to about 0.2 wt. %.

A wide variety of other additional additives can also be included in the polymer composition, such as lubricants, thermally conductive fillers, pigments (e.g., carbon black), antioxidants, stabilizers, surfactants, waxes, flame retardants, anti-drip additives, nucleating agents (e.g., boron nitride), tribological agents (e.g., fluoropolymers), antistatic fillers (e.g., carbon nanotubes, carbon fibers, ionic liquids, carbon black, etc.), dielectric fillers, flow modifiers (e.g., aluminum trihydrate), and other materials added to enhance properties and processability. Lubricants, for example, may be employed in the polymer composition that are capable of withstanding the processing conditions of the liquid crystalline polymer without substantial decomposition. Examples of such lubricants include fatty acids esters, the salts thereof, esters, fatty acid amides, organic phosphate esters, and hydrocarbon waxes of the type commonly used as lubricants in the processing of engineering plastic materials, including mixtures thereof. Suitable fatty acids typically have a backbone carbon chain of from about 12 to about 60 carbon atoms, such as myristic acid, palmitic acid, stearic acid, arachic acid, montanic acid, octadecinic acid, parinric acid, and so forth. Suitable esters include fatty acid esters, fatty alcohol esters, wax esters, glycerol esters, glycol esters and complex esters. Fatty acid amides include fatty primary amides, fatty secondary amides, methylene and ethylene bisamides and alkanolamides such as, for example, palmitic acid amide, stearic acid amide, oleic acid amide, N,N′-ethylenebisstearamide and so forth. Also suitable are the metal salts of fatty acids such as calcium stearate, zinc stearate, magnesium stearate, and so forth; hydrocarbon waxes, including paraffin waxes, polyolefin and oxidized polyolefin waxes, and microcrystalline waxes. Particularly suitable lubricants are acids, salts, or amides of stearic acid, such as pentaerythritol tetrastearate, calcium stearate, or N,N′-ethylenebisstearamide. When employed, the lubricant(s) typically constitute from about 0.05 wt. % to about 1.5 wt. %, and in some embodiments, from about 0.1 wt. % to about 0.5 wt. % (by weight) of the polymer composition.

The components used to form the polymer composition may be combined together using any of a variety of different techniques as is known in the art. In one particular embodiment, for example, the bio-LCP and other optional additives may be melt processed as a mixture within an extruder to form the polymer composition. The mixture may be melt-kneaded in a single-screw or multi-screw extruder at a temperature of from about 250° C. to about 450° C. In one embodiment, the mixture may be melt processed in an extruder that includes multiple temperature zones. The temperature of individual zones is typically set within about −60° C. to about 25° C. relative to the melting temperature of the liquid crystalline polymer. By way of example, the mixture may be melt processed using a twin screw extruder such as a Leistritz 18-mm co-rotating fully intermeshing twin screw extruder. A general purpose screw design can be used to melt process the mixture. In one embodiment, the mixture including all of the components may be fed to the feed throat in the first barrel by means of a volumetric feeder. In another embodiment, different components may be added at different addition points in the extruder, as is known. For example, the liquid crystalline polymer may be applied at the feed throat, and certain additives (e.g., dielectric filler) may be supplied at the same or different temperature zone located downstream therefrom. Regardless, the resulting mixture can be melted and mixed then extruded through a die. The extruded polymer composition can then be quenched in a water bath to solidify and granulated in a pelletizer followed by drying.

The liquid crystalline polymer and/or polymer composition containing the polymer may be molded into any of a variety of different shaped parts using techniques as is known in the art. For example, the shaped parts may be molded using a one-component injection molding process in which dried and preheated plastic granules are injected into the mold. Regardless of the molding technique employed, the polymer is well-suited for forming electronic parts having a small dimensional tolerance. Such parts, for example, generally contain at least one micro-sized dimension (e.g., thickness, width, height, etc.), such as from about 500 micrometers or less, in some embodiments from about 50 to about 450 micrometers, and in some embodiments, from about 100 to about 400 micrometers.

One such part is a fine pitch electrical connector. More particularly, such electrical connectors are often employed to detachably mount a central processing unit (“CPU”) to a printed circuit board. The connector may contain insertion passageways that are configured to receive contact pins. These passageways are defined by opposing walls, which may be formed from a thermoplastic resin. To help accomplish the desired electrical performance, the pitch of these pins is generally small to accommodate a large number of contact pins required within a given space. This, in turn, requires that the pitch of the pin insertion passageways and the width of opposing walls that partition those passageways are also small. For example, the walls may have a width of from about 500 micrometers or less, in some embodiments from about 50 to about 450 micrometers, and in some embodiments, from about 100 to about 400 micrometers. The polymer of the present invention is particularly well suited to form the walls of a fine pitch connector. In addition to or in lieu of the walls, it should also be understood that any other portion of a housing of the connector may also be formed from the polymer composition. For example, the connector may also include a shield that encloses the housing. Some or all of the shield may be formed from the polymer composition. For example, the housing and the shield can each be a one-piece structure unitarily molded from the polymer or a polymer composition containing the polymer. Likewise, the shield can be a two-piece structure that includes a first shell and a second shell, each of which may be formed from the polymer or a polymer composition containing the polymer.

Of course, the polymer may also be used in a wide variety of other components. For example, the polymer and/or polymer composition may be molded into a planar substrate for use in an electronic component. The substrate may be thin, such as having a thickness of about 500 micrometers or less, in some embodiments from about 50 to about 450 micrometers, and in some embodiments, from about 100 to about 400 micrometers. In one embodiment, for example, the planar substrate may be applied with one or more conductive elements using a variety of known techniques (e.g., laser direct structuring, electroplating, etc.). The conductive elements may serve a variety of different purposes. In one embodiment, for example, the conductive elements form an integrated circuit, such as those used in SIM cards. In another embodiment, the conductive elements form antennas of a variety of different types, such as antennae with resonating elements that are formed from patch antenna structures, inverted-F antenna structures, closed and open slot antenna structures, loop antenna structures, monopoles, dipoles, planar inverted-F antenna structures, hybrids of these designs, etc. The resulting antenna structures may be incorporated into the housing of a relatively compact portable electronic component, such as described above, in which the available interior space is relatively small.

A planar substrate that is formed form the polymer and/or polymer composition described above may also be employed in other applications. For example, in one embodiment, the planar substrate may be used to form a base of a compact camera module (“CCM”), which is commonly employed in wireless communication devices (e.g., cellular phone). The compact camera module may contain a lens assembly that overlies a base. The base, in turn, overlies an optional main board. Due to their relatively thin nature, the base and/or main board are particularly suited to be formed from the polymer or polymer composition as described above. The lens assembly may have any of a variety of configurations as is known in the art, and may include fixed focus-type lenses and/or auto focus-type lenses. In one embodiment, for example, the lens assembly is in the form of a hollow barrel that houses lenses, which are in communication with an image sensor positioned on the main board and controlled by a circuit. The barrel may have any of a variety of shapes, such as rectangular, cylindrical, etc. In certain embodiments, the barrel may also be formed from the polymer composition and have a wall thickness within the ranges noted above. It should be understood that other parts of the camera module may also be formed from the polymer or a polymer composition containing the polymer. For example, a polymer film (e.g., polyester film) and/or thermal insulating cap may cover the lens assembly. In some embodiments, the film and/or cap may also be formed from the polymer.

Yet other possible electronic components that may employ the polymer include, for instance, cellular telephones, laptop computers, small portable computers (e.g., ultraportable computers, netbook computers, and tablet computers), wrist-watch devices, pendant devices, headphone and earpiece devices, media players with wireless communications capabilities, handheld computers (also sometimes called personal digital assistants), remote controllers, global positioning system (GPS) devices, handheld gaming devices, battery covers, speakers, camera modules, integrated circuits (e.g., SIM cards), housings for electronic devices, electrical controls, circuit breakers, switches, power electronics, printer parts, etc.

The present invention may be better understood with reference to the following examples and test methods.

### Test Methods

Melt Viscosity: The melt viscosity (Pa-s) may be determined in accordance with ISO 11443:2021 at a shear rate of 400 s⁻¹ or 1,000 s⁻¹ and temperature 15° C. above the melting temperature (e.g., about 325° C.) using a Dynisco LCR7001 capillary rheometer. The rheometer orifice (die) may have a diameter of 1 mm, length of 20 mm, L/D ratio of 20.1, and an entrance angle of 180°. The diameter of the barrel may be 9.55 mm+0.005 mm and the length of the rod may be 233.4 mm.

Melting Temperature: The melting temperature (“Tm”) may be determined by differential scanning calorimetry (“DSC”) as is known in the art. The melting temperature is the differential scanning calorimetry (DSC) peak melt temperature as determined by ISO 11357-3:2018. Under the DSC procedure, samples were heated and cooled at 20° C. per minute as stated in ISO Standard 10350 using DSC measurements conducted on a TA Q2000 Instrument.

Deflection Temperature Under Load (“DTUL”): The deflection under load temperature may be determined in accordance with ISO 75-2:2013 (technically equivalent to ASTM D648). More particularly, a test strip sample having a length of 80 mm, thickness of 10 mm, and width of 4 mm may be subjected to an edgewise three-point bending test in which the specified load (maximum outer fibers stress) was 1.8 Megapascals. The specimen may be lowered into a silicone oil bath where the temperature is raised at 2° C. per minute until it deflects 0.25 mm (0.32 mm for ISO Test No. 75-2:2013).

Tensile Modulus, Tensile Stress, and Tensile Elongation: Tensile properties may be tested according to ISO 527:2019 (technically equivalent to ASTM D638). Modulus and strength measurements may be made on the same test strip sample having a length of 80 mm, thickness of 10 mm, and width of 4 mm. The testing temperature may be 23° C., and the testing speeds may be 1 or 5 mm/min.

Flexural Modulus, Flexural Stress, and Flexural Elongation: Flexural properties may be tested according to ISO 178:2019 (technically equivalent to ASTM D790). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO 179-1:2010 (technically equivalent to ASTM D256-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be 23° C.

Dielectric Constant (“Dk”) and Dissipation Factor (“Df”): The dielectric constant (or relative static permittivity) and dissipation factor are determined using a known split-post dielectric resonator technique, such as described in Baker-Jarvis, et al., IEEE Trans. on Dielectric and Electrical Insulation, 5(4), p. 571 (1998) and Krupka, et al., Proc. 7^{th} International Conference on Dielectric Materials: Measurements and Applications, IEEE Conference Publication No. 430 (September 1996). More particularly, a plaque sample having a size of 80 mm×90 mm×3 mm or a disc having a diameter of 101.6 mm and thickness of 3 mm was inserted between two fixed dielectric resonators. The resonator measured the permittivity component in the plane of the specimen. Five (5) samples are tested and the average value is recorded. The split-post resonator can be used to make dielectric measurements in the low gigahertz region, such as 2 GHz.

Heat Cycle Test: Specimens are placed in a temperature control chamber and heated/cooled within a temperature range of from −30° C. and 100° C. Initially, the samples are heated until reaching a temperature of 100° C., when they were immediately cooled. When the temperature reaches −30° C., the specimens are immediately heated again until reaching 100° C. Twenty three (23) heating/cooling cycles may be performed over a 3-hour time period.

### Comparative Example 1

LCP 1 is formed from about 42.86% HBA, 20% NDA, 8.57% TA, and 28.57% HQ. LCP 1 has a melting temperature of about 325° C. and a melt viscosity of about 26 Pa-s as determined at a shear rate of 1,000 s⁻¹.

### Example 1

LCP 2 is formed from about 42.86% HBA, 20% NDA, 3.57% TA, 5% FDCA, and 28.57% HQ. LCP 2 has a melting temperature of about 307° C. and a melt viscosity of about 35 Pa-s as determined at a shear rate of 1,000 s⁻¹.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A bio-liquid crystalline polymer comprising:
(i) aromatic dicarboxylic acid repeating units derived from one or more aromatic dicarboxylic acids, wherein the aromatic dicarboxylic acids include one or more furanyl dicarboxylic acids;
(ii) aromatic diol repeating units derived from one or more aromatic diols, and
(iii) optionally, aromatic hydroxycarboxylic acid repeating units derived from one or more aromatic hydroxycarboxylic acids;
wherein the total amount of repeating units derived from naphthenic hydroxycarboxylic and/or dicarboxylic acids is about 10 mol. % or more, and further wherein the polymer exhibits a melt viscosity of from about 0.1 to about 150 Pa-s, as determined at a shear rate of 1,000 seconds⁻¹ and temperature of about 15° C. greater than the melting temperature of the polymer composition in accordance with ISO 11443:2021.

2. The bio-liquid crystalline polymer of claim 1, wherein the furanyl dicarboxylic acids include 2,5-furandicarboxylic acid, 2,2′-bifuran-5,5′-dicarboxylic acid, or a combination thereof.

3. The bio-liquid crystalline polymer of claim 1, wherein the repeating units derived from furanyl dicarboxylic acids constitute from about 1 mol. % to about 60 mol. % of the polymer.

4. The bio-liquid crystalline polymer of claim 1, wherein the aromatic dicarboxylic acid repeating units are formed entirely from furanyl dicarboxylic acids.

5. The bio-liquid crystalline polymer of claim 1, wherein the aromatic dicarboxylic acids further include one or more additional aromatic dicarboxylic acids.

6. The bio-liquid crystalline polymer of claim 5, wherein the additional aromatic dicarboxylic acids include 2,6-naphthalenedicarboxylic acid, terephthalic acid, isophthalic acid, or a combination thereof.

7. The bio-liquid crystalline polymer of claim 5, wherein the additional aromatic dicarboxylic acids constitute from about 40 mol. % to about 99 mol. % of the total amount of aromatic dicarboxylic acids and the furanyl dicarboxylic acids constitute from about 1 mol. % to about 60 mol. % of the total amount aromatic dicarboxylic acids.

8. The bio-liquid crystalline polymer of claim 5, wherein the polymer contains repeating units derived from 2,6-naphthalenedicarboxylic acid in an amount of from about 10 mol. % to about 40 mol. %.

9. The bio-liquid crystalline polymer of claim 1, wherein the total amount of repeating units derived from terephthalic acid and/or isophthalic acid is about 20 mol. % or less of the polymer.

10. The bio-liquid crystalline polymer of claim 1, wherein the polymer contains aromatic hydroxycarboxylic acid repeating units.

11. The bio-liquid crystalline polymer of claim 1, wherein the polymer contains aromatic hydroxycarboxylic acid repeating units derived from 4-hydroxybenzoic acid, 6-hydroxy-2-naphthoic acid, or a combination thereof.

12. The bio-liquid crystalline polymer of claim 11, wherein the polymer contains repeating units derived from 4-hydroxybenzoic acid in an amount of from about 10 mol. % to about 70 mol. %.

13. The bio-liquid crystalline polymer of claim 1, wherein the molar ratio of repeating units derived from 4-hydroxybenzoic acid to repeating units derived from furanyl dicarboxylic acids is from about 1 to about 20.

14. The bio-liquid crystalline polymer of claim 1, wherein the aromatic diols include hydroquinone, 4,4′-biphenol, or a combination thereof.

15. The bio-liquid crystalline polymer of claim 1, wherein the polymer containing repeating units derived from hydroquinone and/or 4,4′-biphenol in an amount of from about 5 mol. % to about 40 mol. %.

16. The bio-liquid crystalline polymer of claim 1, wherein the polymer is wholly aromatic.

17. The bio-liquid crystalline polymer of claim 1, wherein the furanyl dicarboxylic acids are obtained from a renewable feedstock.

18. The bio-liquid crystalline polymer of claim 1, wherein the polymer has a melting temperature of from about 280° C. to about 400° C.

19. The bio-liquid crystalline polymer of claim 1, wherein the polymer exhibits a dielectric constant of about 5 or less and a dissipation factor of about 0.05 or less as determined at a frequency of 2 GHz.

20. A polymer composition of claim 1, wherein the composition contains the bio-liquid crystalline polymer and one or more optional additives.
